(19) United States
(12) Patent Application Publication
(10) Pub. No.: US 2011/0189383 A1
(43) Pub. Date: Aug. 4, 2011

(54) Device and Method for Inert Gas Cure for Leadframe or Substrate Strips

(75) Inventor: Bernhard P. LANGE, Freising (DE)

(73) Assignee: TEXAS INSTRUMENTS DEUTSCHLAND GMBH, Freising (DE)

(21) Appl. No.: 13/015,907

(22) Filed: Jan. 28, 2011

(30) Foreign Application Priority Data
Feb. 1, 2010 (DE) 10 2010 006 393.2

(51) Int. Cl. F27B 5/16; B05D 5/12

(52) U.S. Cl. 427/58; 432/201

(57) ABSTRACT

A cover for use in a cure oven, wherein the cover is configured to enclose an inner volume of a storage cassette air-tightly. The storage cassette is of the kind to store a plurality of leadframe or substrate strips having a die overcoat to be cured. The cover comprises a first opening for supplying an inert gas to the storage cassette and a second opening for letting the inert gas off. A box for use in a cure oven, the box including a storage cassette configured to store a plurality of leadframe or substrate strips having a die overcoat to be cured and a cover to enclose the plurality of leadframe or substrate strips in the storage cassette air-tightly. A first opening is provided for supplying an inert gas to the storage cassette and a second opening is provided for letting the inert gas off. A method of curing a die over coat on a leadframe or substrate, including arranging a plurality of leadframe or substrate strips having a die overcoat to be cured in a storage cassette and enclosing the leadframe or substrate strips in the storage cassette air-tightly in a box which has a first and a second opening. The box is placed in a cure oven and by the first opening an inert gas is supplied into the box for preventing oxidation of the leadframe or substrate strips. The cure oven is heated to cure the die overcoat.

### FIELD OF THE INVENTION

The invention relates to a device and a method for inert gas cure for leadframe or substrate strips.

### BACKGROUND OF THE INVENTION

Leadframe or substrate strips with polymide (PI) on top of bonded chips are carried and stored in storage cassettes, mostly made of metal. The storage cassettes are placed in a temperature cure oven for a high temperature cure process in order to cure the liquid PI. With the curing process, the liquid PI is transformed into a robust and solid state for protecting the pressure sensitive die surface of high precision parts of the chips. For example, high precision analog parts are protected with this kind of die over coat, which is applied in the assembly sites after mounting and bonding the dies on the leadframes or substrates. Substrates possibly on the base of polymide with copper lines are for example used for ball grid arrays and may also need a die over coat cure. The die over coat needs to be cured at about 300° C. under an inert gas atmosphere, e.g. in a nitrogen purged oven. FIG. 1 shows a conventional arrangement, according to which several cassettes 10 with leadframe or substrate strips 12 are placed in a cure oven 14. A pipe 16 is provided and coupled to the cure oven 14 for supplying nitrogen (N2) to the oven. The nitrogen serves to establish an oxygen-free atmosphere during the cure process. Otherwise, oxidation of the leadframe or substrate contact surfaces will take place during the curing process leading to lower solderable component leads. Even small amounts of remaining oxygen can degrade the solderablety.

Due to the volume of a cure oven, it requires strong efforts to completely remove oxygen from the cure oven in terms of flushing rate and amount of nitrogen. Furthermore, not all cure ovens available are completely gas tight resulting in a remaining oxygen level within the oven atmosphere.

### SUMMARY OF THE INVENTION

It is an object of the invention to provide a method and a device for improved curing of leadframes or substrates.

In one aspect of the invention, there is provided a cover for use in a cure oven. The cover is configured to enclose an inner volume of a storage cassette air-tightly. The storage cassette is of the kind to store a plurality of leadframe or substrate strips having a die overcoat to be cured. Advantageously, this storage cassette may be the same storage cassette as used in the state of the art in which the bonded chips are carried and stored. The cover is provided with a first opening for supplying an inert gas to the storage cassette and with a second opening for letting the inert gas off.

In one aspect of the invention, the cover encloses the complete storage cassette. No changes are required on the storage cassettes. The cover may be formed by two lids, the two lids being attachable to each other air-tightly.

In another aspect of the invention, the storage cassette is open only on two sides and the cover is formed as two lids being attachable air-tightly to the storage cassette. When the storage cassette itself is already provided with air-tight walls, it is not necessary to have an additional cover at these sides. Thus, two lids attached to the storage cassette are sufficient to enclose the leadframes or substrates and the volume enclosed around the leadframe or substrate strips is even smaller and less material is needed for the cover.

The lids may be adapted to the storage cassette to be covered so as to extend over the storage cassette sufficiently to cover together all openings of the storage cassette.

A smaller volume is easier and faster to purge. Heat transfer to the enclosed volume and thus to the leadframe or substrate strips is less hindered. The material used for the cover and the storage cassette should allow for good heat transfer. Usually, the storage cassettes are made of metal and in an aspect of the invention the cover may also be made of metal.

In an aspect of the invention, the air-tight sealing of the volume enclosed inside the storage cassette between the lid and the storage cassette or between two parts of the cover is achieved by a rubber type fitting or seal.

To the first opening, a pipe of the kind used in the state of the art for coupling to the cure oven may be coupled directly to the cover for supplying the inert gas, for example nitrogen. The second opening allows output of the inert gas. The second opening may be coupled to a pipe leading either to a second storage cassette or to an exhaust pipe system. As the cover encloses the plurality of leadframe or substrate strips air-tightly, the inert gas atmosphere must only be provided inside the storage cassette and not inside the whole cure oven.

The invention further provides a box for use in a cure oven, the box comprising a storage cassette and a cover according to the invention. The cover may be formed as a front and a back cover. With the cover the storage cassette is sealed air-tightly form the inside oven gas environment.

In a further aspect of the invention, the second opening is configured to be coupleable via a second pipe to the first opening of a second box, so as to form a chain. In the case where a plurality of boxes is put into the cure oven to be cured at the same time, this allows a continuous flow of nitrogen through all boxes. Otherwise it is of course also possible to connect a plurality of boxes in parallel to a gas supply.

In an aspect of the invention, the box has a volume which is small compared to the inside volume of the cure oven. The smaller the volume is the better an oxygen-free atmosphere can be realized.

In another aspect of the invention, the first opening for supplying the inert gas is arranged on an end of the box opposite to the end where the second opening is arranged. To provide an oxygen-free atmosphere it must be ascertained that the inert gas fills out completely the volume of the box. Therefore, the two openings must be arranged on the box in a way to make sure that the inert gas will fill up the whole volume.

The invention further provides a method for curing a die overcoat on a leadframe or substrate. The method comprises arranging a plurality of leadframe or substrate strips having a die overcoat to be cured in a storage cassette. The method further comprises enclosing the leadframe or substrate strips in the storage cassette air-tightly in a box which has a first and a second opening. The box is placed in a cure oven and an inert gas is supplied by the first opening into the box for preventing oxidation of the leadframe or substrate strips. The cure oven is heated to cure the die overcoat. Usually, the temperature necessary for curing is about 300° C. The temperature depends of course on the die overcoat used. To make sure that the leadframes or substrates are heated sufficiently, the material used for the cover and the storage cassette must allow for good heat transfer. Usually, the storage cassettes are made of metal and in an aspect of the invention the cover may also be made of metal.

In a further aspect of the invention, the method further comprises preheating the inert gas before being supplied into the box. Thus, the heat is not only transferred by the cover and the walls of the storage cassette, but also by the inert gas itself. Preheating of the inert gas flow may be achieved by a coil design of the pipe coupled to the first opening being located inside the cure oven.

In a further aspect of the invention, the method comprises the step of supplying the inert gas at the beginning of the cure process with a first flush rate and supplying the inert gas during the cure process temperature ramp with a second flush rate, wherein the first flush rate is higher than the second flush rate. Thus, in a first time the oxygen is flushed out and afterwards the pressure is sufficient to maintain the inert gas or nitrogen atmosphere.

### BRIEF DESCRIPTION OF DRAWINGS

Further advantages and characteristics of the invention ensue from the description below of an example embodiment and from the accompanying drawings, in which:

FIG. 1 is a schematic view of storage cassettes arranged in a cure oven according to the state of the art;

FIG. 2 is a schematic view of an arrangement of boxes in a cure oven according to the invention;

FIG. 3 shows schematically in a simplified perspective drawing a box comprising two lids according to the invention;

FIG. 4 shows schematically a cross-section of the box along the line A in FIG. 3.

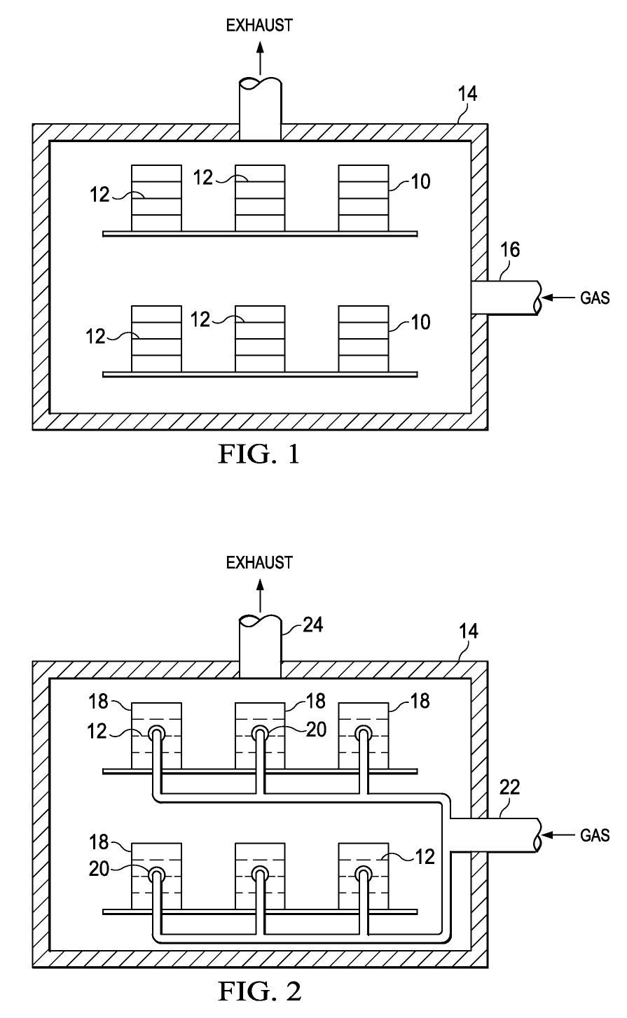

### DETAILED DESCRIPTION OF AN EXAMPLE EMBODIMENT

FIG. 2 shows schematically a cure oven 14 in which six boxes 18 are placed. Inside each of boxes 18 a storage cassette 10 comprises leadframe strips 12 which are indicated by dashed lines. The embodiment will be explained for leadframe strips but it is of course possible to place substrate strips in the storage cassette. Each box comprises a first opening 20 to which a pipe 22 is connected. In the embodiment shown in FIG. 2 the boxes 18 are connected in parallel by the pipe 22. An inert gas, for example nitrogen, is supplied to pipe 22 and, thus, to boxes 18. Each box 18 further comprises a second opening which is not visible in FIG. 2 and which may be opposite to first opening 20 allowing evacuation of gases from inside the box. Cure oven 14 is provided with an exhaust 24 allowing evacuation of gases from inside the cure oven.

In function, leadframe strips 12 are covered with a die overcoat which is to be cured. Boxes 18 are air-tightly sealed. The inert gas is supplied to boxes 18 through pipe 22 at the beginning of the cure process with a first flush rate. The inert gas is introduced by first openings 20 into boxes 18. Thus, the air inside boxes 18 is pushed out through the second opening provided in each box 18. The gas pushed out of boxes 18 can leave cure oven 14 by exhaust 24.

After a first time period which is judged to be sufficient to provide an oxygen-free atmosphere inside boxes 18, the temperature of cure oven 14 is augmented in a cure process temperature ramp. The gas supply to boxes 18 is reduced to a second flush rate which is lower than the first flush rate. With the gas flowing with the second flush rate the oxygen-free atmosphere in boxes 18 is maintained. Compared to flush rates used when the complete oven volume must be oxygen-free, smaller flush rates are necessary when using boxes 18.

If it is necessary to prevent oxygen to enter by the second opening, which depends on the partial pressure, the second opening may be coupled to an exhaust pipe system. Therefore, it is possible to couple a pipe to the second opening. The heat in the oven is transferred via the walls of boxes 18 and the atmosphere inside the boxes 18 to the leadframe strips 12 and the die overcoat is cured.

In a preferred embodiment which is not shown in FIG. 2, gas pipe 22 is formed in a coil inside the cure oven before being branched to the different boxes 18. In an aspect of the invention, this pipe coil is placed near a heating element of cure oven 14. Thus, the inert gas flowing through pipe 22 is preheated before being supplied to boxes 18. This allows heating the leadframe strips faster which shortens the overall cure process time and decreases the costs of the cure process.

FIG. 2 shows an embodiment, in which the boxes are coupled in parallel to the gas supply. In another embodiment, the boxes may be coupled in series, the second opening of a box being coupled via a pipe to a first opening of another box.

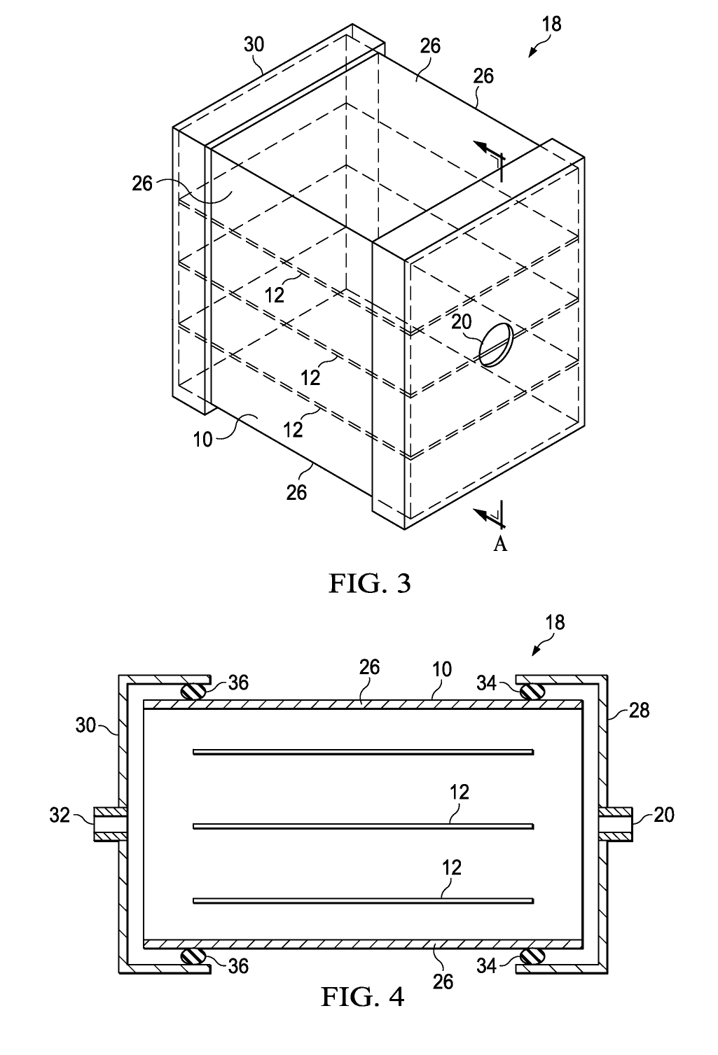

FIG. 3 shows a simplified schematic perspective view of a box 18. Box 18 comprises a storage cassette 10 in which in dashed lines the arrangement planes for the leadframe strips 12 are indicated. Storage cassette 10 comprises four air-tight walls 26 which do not need to be covered. The sides of storage cassette 10 which are open and by which the leadframe strips 12 are introduced to the storage cassette are closed by two lids 28, 30. Lids 28, 30 are provided with one opening each, a first opening 20 is visible in FIG. 3 whereas a second opening on the lid 30 is not shown. First opening 20 is configured to be coupled via a first pipe to an inert gas supply. The second opening may be configured to be coupleable via a second pipe to the first opening of a second box. Lids 28 and 30 are air-tightly attached to storage cassette 10. Thus, walls 26 and lids 28 and 30 enclose a volume in which the leadframe strips may be cured under an inert gas atmosphere.

FIG. 4 shows box 18 of FIG. 3 in a cross-section view. Lid 28 comprises first opening 20 and lid 30 comprises second opening 32. Between lids 28 and 30 and storage cassette 10 seals 34 and 36 are placed. Seals 34 and 36 are configured to air-tightly seal the volume enclosed by box 18, i.e. to close any gap between lids 28, 30 and storage cassette walls 26. Any known kind of seal may be used, in an embodiment it is a rubber type seal. Of course, the seal must support the cure temperatures and the inert gas.

Although the invention has been described hereinabove with reference to a specific embodiment, it is not limited to this embodiment and no doubt further alternatives will occur to the skilled person that lie within the scope of the invention as claimed.

1. A cover for use in a cure oven,
the cover being configured to enclose an inner volume of a storage cassette air-tightly; the storage cassette being of the kind to store a plurality of leadframe or substrate strips having a die overcoat to be cured; the cover comprising
a first opening for supplying an inert gas to the storage cassette; and
a second opening for letting the inert gas off.

2. The cover of claim 1, wherein the cover encloses the complete storage cassette.

3. The cover of claim 2, wherein the cover is formed as two lids, the two lids being attachable to each other air-tightly.

4. The cover of claim 1, wherein the cover is formed as two lids being attachable air-tightly to the storage cassette.

5. The cover of claim 4, wherein the two lids are adapted to the storage cassette to be covered, so as to cover together all openings of the storage cassette.

6. The cover of claim 1, wherein the air-tight sealing is achieved by a rubber type fitting.

7. The cover of claim 1, wherein the first opening is configured to be coupled via a first pipe to an inert gas supply.

8. The cover of claim 7, wherein the second opening is configured to be coupled via a second pipe to the first opening of a second box, so as to form a chain, or to be coupled to an exhaust pipe system.

9. A box for use in a cure oven, the box comprising
a storage cassette configured to store a plurality of leadframes or substrate strips having a die overcoat to be cured;
a cover according to claim 1.

10. The box according to claim 9, wherein the volume of the box is small compared to the inside volume of the cure oven such that a plurality of boxes can be placed in the cure oven at the same time.

11. The box according to claim 9, wherein the first opening for supplying the inert gas is arranged on an end of the box opposite to the end where the second opening is arranged.

12. A method of curing a die overcoat on a leadframe or a substrate, comprising:
arranging a plurality of leadframe or substrate strips having a die overcoat to be cured in a storage cassette;
enclosing the leadframe or substrate strips in the storage cassette air-tightly in a box which has a first and a second opening;
placing the box in a cure oven;
supplying by the first opening an inert gas into the box for preventing oxidation of the leadframe or substrate strips;
heating the cure oven to cure the die overcoat.

13. The method of claim 12, further comprising preheating the inert gas before being supplied into the box.

14. The method according to claim 12, wherein
the step of supplying an inert gas comprises supplying the inert gas at the beginning of the cure process with a first flush rate and supplying the inert gas during a cure process temperature ramp with a second flush rate, wherein the first flush rate is higher than the second flush rate.
